(19) United States
(12) Patent Application Publication
(10) Pub. No.: US 2023/0421432 A1
(43) Pub. Date: Dec. 28, 2023

(54) COMMUNICATION APPARATUS AND COMMUNICATION SYSTEM

(71) Applicant: CANON KABUSHIKI KAISHA, Tokyo (JP)

(72) Inventor: MOTOHARU SUZUKI, Kanagawa (JP)

(21) Appl. No.: 18/337,345

(22) Filed: Jun. 19, 2023

(30) Foreign Application Priority Data
Jun. 24, 2022 (JP) 2022-101714

(51) Int. Cl. H04L 41/0654; H04L 45/00

(52) U.S. Cl. CPC H04L 41/0654; H04L 45/22

(57) ABSTRACT

A communication apparatus includes an input unit configured to be input a packet from a first communication line, an output unit configured to output the packet to a second communication line, a processing unit configured to process the packet, a switching unit configured to switch a path for outputting, from the output unit, the packet input from the input unit between a normal path passing through an access point that the processing unit can access and a bypass path not passing through the access point, a detection unit configured to detect a specific packet that satisfies a specific condition from among a plurality of packets in a state where the path is switched to the bypass path by the switching unit, and a changing unit configured to change a state of the communication apparatus in a case where the specific packet is detected.

### BACKGROUND

### Field

The present disclosure relates to a communication apparatus and a communication system.

### Description of the Related Art

A daisy chain topology such as a ring type topology or a line type topology is sometimes used as a connection form (topology) of a communication apparatus in a communication system.

For example, according to Japanese Patent Application Laid-Open No. 2014-220551, a node device is discussed which is provided with bypass means that ensures communication of an entire system even in a case where a function of the node device is lost in daisy chain connection.

In a bypass mode, a packet from an input side is directly output to an output side, so that the packet does not reach a central processing unit (CPU) or the like that performs control in a communication apparatus. Thus, it is difficult to remotely control the communication apparatus from the outside using a communication network. However, remote control is often desired in order to restore a function or the like of the communication apparatus.

### SUMMARY

Various embodiments of the present disclosure are directed to the provision of a communication apparatus and a communication system that can be remotely controlled in a bypass mode.

According to one embodiment of the present disclosure, a communication apparatus includes an input unit configured to be input a packet from a first communication line, an output unit configured to output the packet to a second communication line, a processing unit configured to process the packet, a switching unit configured to switch a path for outputting, from the output unit, the packet input from the input unit between a normal path passing through an access point that the processing unit can access and a bypass path not passing through the access point, a detection unit configured to detect a specific packet that satisfies a specific condition from among a plurality of packets in a state where the path is switched to the bypass path by the switching unit, and a changing unit configured to change a state of the communication apparatus in a case where the specific packet is detected.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of a network system (a communication system) according to an exemplary embodiment.

FIG. 2 is a block diagram illustrating a configuration example of a communication apparatus according to the present exemplary embodiment.

FIG. 3 illustrates a bypass unit in a state where a communication path is switched to a first path.

FIG. 4 illustrates the bypass unit in a state where the communication path is switched to a second path.

FIG. 5 is a first flowchart illustrating bypass change processing.

FIG. 6 is a second flowchart illustrating the bypass change processing.

FIG. 7 is a third flowchart illustrating the bypass change processing.

FIG. 8 illustrates an example of a remote control packet.

FIG. 9 illustrates a correspondence relationship among a remote control type, a remote control field, and an interrupt signal.

FIG. 10 is a first flowchart illustrating processing operations in the communication apparatus.

FIG. 11 is a second flowchart illustrating the processing operations in the communication apparatus.

### DESCRIPTION OF THE EMBODIMENTS

Exemplary embodiments of the present disclosure will be described in detail below with reference to the attached drawings. It is to be noted that the following exemplary embodiments are not meant to limit the scope of the present invention as encompassed by the appended claims. Further, not all combinations of features described in the exemplary embodiments are essential for solving means of the present disclosure. Configurations of the exemplary embodiments can be appropriately modified or changed according to specifications and various conditions (use conditions, use environments, and the like) of a system and an apparatus to which features of the present disclosure are applied. The technical scope of the present invention is defined by the claims and not by the individual exemplary embodiments described below.

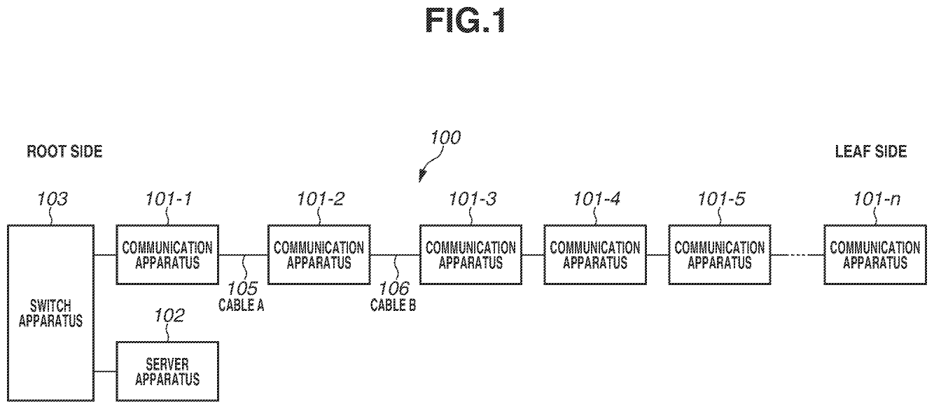

FIG. 1 is a block diagram illustrating a configuration example of a network system (a communication system) according to the present exemplary embodiment.

A network system 100 according to the present exemplary embodiment includes a plurality of communication apparatuses 101-1 to 101-n (n>1) connected in a line, a server apparatus 102, and a switch apparatus 103. In the following description, each of the plurality of communication apparatuses 101-1 to 101-n is collectively referred to as the communication apparatus 101.

In the network in which the plurality of communication apparatuses 101-1 to 101-n is connected, a side closer to the switch apparatus 103 is referred to as a root side, and a side farther from the switch apparatus 103 is referred to as a leaf side. Also in each communication apparatus 101, a side closer to the switch apparatus 103 is referred to as the root side, and a side farther from the switch apparatus 103 is referred to as the leaf side.

The communication apparatus 101 includes two interface units, that is an interface unit on the root side and an interface unit on the leaf side, as will be described below. The interface units can be respectively connected to the other communication apparatuses 101 via cables 105 and 106. With these interface units, the communication apparatuses 101 can be used in a communication form in which an arbitrary number of apparatuses is connected in a line.

The communication apparatus 101-1 closest to the root side among the plurality of communication apparatuses 101-1 to 101-n is connected to the switch apparatus 103. Further, the communication apparatus 101-n closest to the leaf side among the plurality of communication apparatuses 101-1 to 101-n is connected only to the communication apparatus 101 immediately before and thus is sufficient to have one interface unit.

The switch apparatus 103 is connected to the server apparatus 102. Each of the communication apparatuses 101 can communicate with the server apparatus 102 via the switch apparatus 103. In other words, the switch apparatus 103 has a function of switching a network including the plurality of communication apparatuses 101-1 to 101-n and the server apparatus 102.

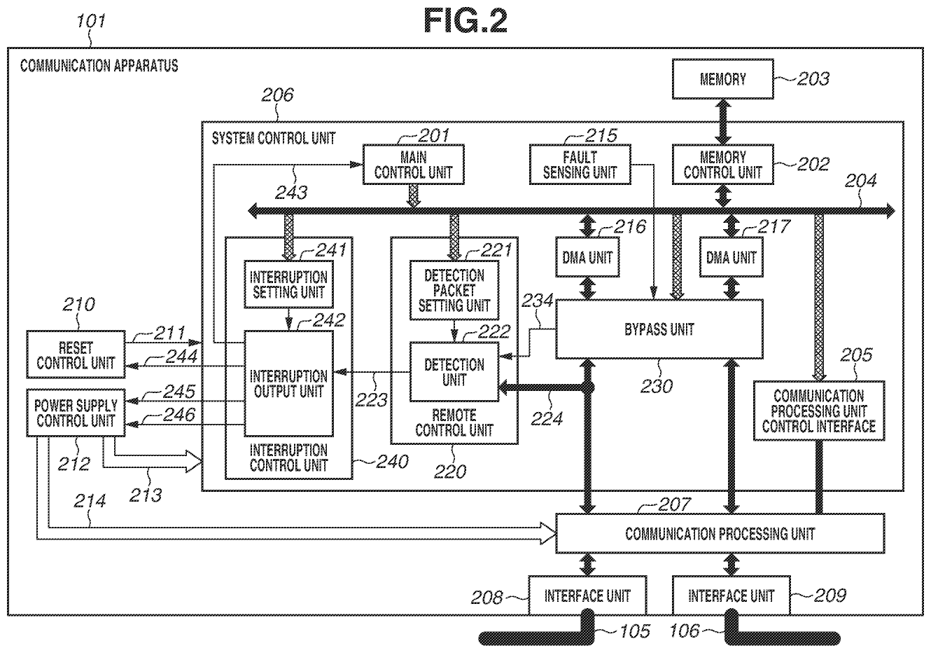

FIG. 2 is a block diagram illustrating a configuration example of the communication apparatus 101 according to the present exemplary embodiment.

The configuration illustrated in FIG. 2 is an example, and a plurality of functional blocks may configure one functional block, or any of functional blocks may be divided into blocks that perform a plurality of functions. Further, at least one functional block may be implemented as hardware. In a case where the functional block is implemented by hardware, for example, a predetermined compiler may be used to automatically generate a dedicated circuit on a field programmable gate array (FPGA) from a program for realizing each step. In the same way as the FPGA, a gate array circuit may be formed and realized as hardware. Further, the functional block may be realized by an application specific integrated circuit (ASIC).

The communication apparatus 101 is connected to the cable 105 on the root side and the cable 106 on the leaf side. The communication apparatus 101 includes an interface unit 208 on the root side, an interface unit 209 on the leaf side, a communication processing unit 207, and a system control unit 206. The communication apparatus 101 also includes a memory 203, a reset control unit 210, and a power supply control unit 212.

The interface unit 208 on the root side is connected to the cable 105 on the root side, and the interface unit 209 on the leaf side is connected to the cable 106 on the leaf side. One of the interface units 208 and 209 functions as an input unit to which a packet is input from a first communication line, and the other functions as an output unit that outputs the packet to a second communication line. The first communication line is the cable 105 or 106, which inputs a packet to the interface unit 208 or 209, of the cables 105 and 106 respectively on the root side and the leaf side. The second communication line is the cable 105 or 106, which outputs a packet from the interface unit 208 or 209, of the cables 105 and 106 respectively on the root side and the leaf side.

The communication processing unit 207 is connected to the other communication apparatuses 101 via the interface unit 208 on the root side and the interface unit 209 on the leaf side. The communication processing unit 207 is also connected to the system control unit 206.

The communication processing unit 207 executes transmission and reception processing corresponding to a physical layer and a logical layer of an open systems interconnection (OSI) reference model. For example, the communication processing unit 207 executes transmission and reception processing corresponding to a physical layer and a logical layer of Ethernet® (registered trademark). Further, the communication processing unit 207 according to the present exemplary embodiment supports a Wake-on-local-area-network (LAN) (WOL) mode. In other words, even in a state where power supply to the system control unit 206 is cut off, the transmission and reception processing can be executed only by the power supply to the communication processing unit 207.

Further, the communication processing unit 207 according to the present exemplary embodiment can determine a power supply state to the system control unit 206 from, for example, states of various signals connected to the system control unit 206. Then, the communication processing unit 207 switches between enable/disable of the WOL mode based on the determined power supply state.

The system control unit 206 is a controller that performs main control on the communication apparatus 101 and is realized by an FPGA, a large-scale integrated circuit (LSI), or an ASIC.

The system control unit 206 includes a main control unit 201, a memory control unit 202, a system bus 204, and a communication processing unit control interface 205. The system control unit 206 also includes a bypass unit 230, a direct memory access (DMA) unit 216 on the root side, and a DMA unit 217 on the leaf side. Further, the system control unit 206 includes a fault sensing unit 215, a remote control unit 220, and an interruption control unit 240.

The memory 203 stores a program of the main control unit 201, a packet received from the outside of the communication apparatus 101 (a received packet), and the like. The memory control unit 202 has a function of enabling various modules to access the memory 203.

The system bus 204 connects the main control unit 201, the memory control unit 202, the DMA units 216 and 217, the interruption control unit 240, the remote control unit 220, the bypass unit 230, and the communication processing unit control interface 205 with each other.

The main control unit 201 includes, for example, one or more central processing units (CPUs) and performs various types of control on the communication apparatus 101. The main control unit 201 can execute various control programs to perform the control. The main control unit 201 can also apply predetermined protocol processing (processing by an upper layer) to the received packet stored in the memory 203 via the system bus 204. In other words, the main control unit 201 functions as a processing unit that processes the received packet. A part or all of processing in a digital region in the system control unit 206 may be performed by the main control unit 201 executing software (a program).

The communication processing unit control interface 205 executes interface processing necessary for the main control unit 201 to set a processing function of the communication processing unit 207. The communication processing unit control interface 205 performs protocol conversion in a case where an interface of a setting function of the communication processing unit 207 does not match a specification of the system bus 204.

The DMA unit 216 on the root side has a function of storing a packet received by the interface unit 208 on the root side and input from the communication processing unit 207 to the system control unit 206 in the memory 203. The DMA unit 216 on the root side also has a function of reading a packet stored in the memory 203 and outputting the packet to the communication processing unit 207 to transmit it from the interface unit 208 on the root side.

The DMA unit 217 on the leaf side is a functional block similar to the DMA unit 216 on the root side. In other words, the DMA unit 217 on the leaf side has a function of storing a packet received by the interface unit 209 on the leaf side and input from the communication processing unit 207 to the system control unit 206 in the memory 203. The DMA unit 217 on the leaf side also has a function of reading a packet stored in the memory 203 and outputting the packet to the communication processing unit 207 to transmit it from the interface unit 209 on the leaf side. The DMA units 216 and 217 are not used in a case where the bypass unit 230 is in a bypass mode and are used in a case where the bypass unit 230 is in a normal mode.

The bypass unit 230 controls a communication path of a signal in the communication apparatus 101. Specifically, the bypass unit 230 performs control to switch between a first path and a second path.

The first path is a path for transmitting a packet received by the communication apparatus 101 from the outside via the communication processing unit 207 to the outside of the communication apparatus 101 via the communication processing unit 207 without changing a content of the packet. The first path is a bypass path through which a packet is not stored in the memory 203 and, in other words, a path that does not pass through an access point that the above-described processing unit can access.

The second path is a normal communication path (a normal path) through which a packet is stored in memory 203. In other words, the second path is a path for storing a packet received by the communication apparatus 101 from the outside via the communication processing unit 207 in the memory 203 via the system bus 204 and the memory control unit 202. The second path is also a path through which the communication apparatus 101 transmits a packet in the memory 203 to the outside thereof via the memory control unit 202, the system bus 204, and the communication processing unit 207. In other words, the second path is a path that passes through an access point that the above-described processing unit can access.

In other words, the bypass unit 230 can switch a path for outputting a packet input from the input unit from the output unit between the normal path and the bypass path.

The communication apparatus 101 may include a display unit that functions as a graphical user interface (GUI).

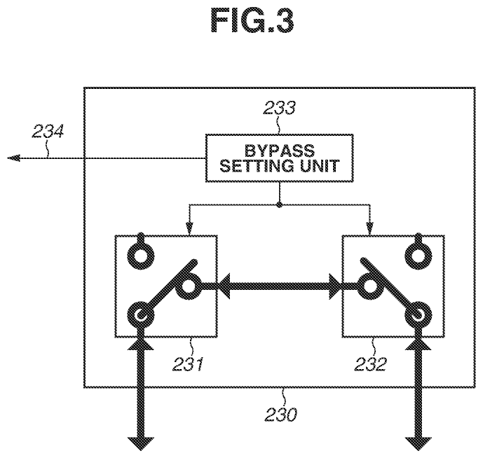

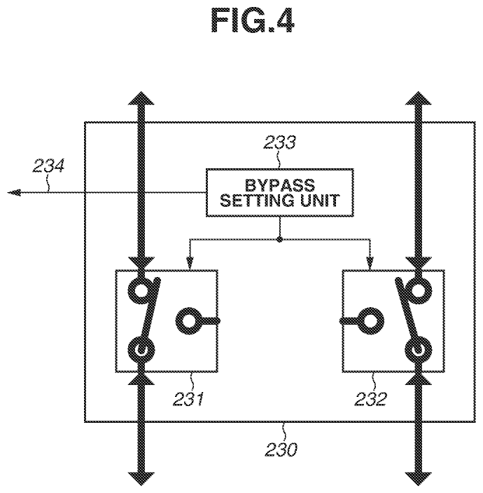

FIG. 3 illustrates the bypass unit 230 in a state where the communication path is switched to the first path. FIG. 4 illustrates the bypass unit 230 in a state where the communication path is switched to the second path.

The bypass unit 230 includes a bus switch 231 on the root side, a bus switch 232 on the leaf side, and a bypass setting unit 233.

The bypass setting unit 233 operates the bus switches 231 and 232 after the mode is set. The bypass setting unit 233 also outputs a bypass state signal 234 indicating the set mode.

The bus switches 231 and 232 execute switching of the communication path by an operation by the bypass setting unit 233. Specifically, the bus switches 231 and 232 switch a path connecting the communication processing unit 207 with the DMA units 216 and 217 to a path connecting the communication processing unit 207 with the other bus switch 231 or 232.

A signal instructing the bypass mode is input to the bypass setting unit 233, and thus the bypass unit 230 is set to the bypass mode. If the bypass unit 230 is set to the bypass mode, each of the bus switches 231 and 232 connects the communication processing unit 207 to the other bus switch 231 or 232 as illustrated in FIG. 3. As a result, the communication path is switched to the bypass path, and the bypass state signal 234 indicating the bypass mode is output.

A signal indicating the normal mode is input to the bypass setting unit 233, and thus the bypass unit 230 is set to the normal mode. If the bypass unit 230 is set to the normal mode, each of the bus switches 231 and 232 connects the communication processing unit 207 to the DMA units 216 and 217 as illustrated in FIG. 4. As a result, the communication path is switched to the normal path, and the bypass state signal 234 indicating the normal mode is output.

In FIGS. 3 and 4, a forward path from the root side to the leaf side and a return path from the leaf side to the root side are illustrated as a common path, but in practice, a part or all of the forward and return paths may be independent of each other.

Returning to FIG. 2, the power supply control unit 212 supplies power to each unit in the communication apparatus 101. In the communication apparatus 101, power is individually supplied to the system control unit 206 and the communication processing unit 207. In other words, power to the system control unit 206 is supplied through a power supply line 213 for system use, and power to the communication processing unit 207 is supplied through a power supply line 214 for communication use.

The reset control unit 210 performs reset control on the system control unit 206. The system control unit 206 performs system reboot processing if a reset signal 211 is asserted.

Specifically, a program to be executed by the main control unit 201 is loaded to the memory 203, an operating system (OS) of the main control unit 201 is started, and all hardware is initialized. Then, an application operating on the OS becomes executable, and communication with the outside also becomes possible.

The fault sensing unit 215 senses a fault by various monitoring processing such as system monitoring and environment monitoring with respect to the communication apparatus 101. The fault sensing unit 215 has, for example, a watchdog function and monitors a fault that is difficult for the main control unit 201 to sense by self-diagnosis and whether the entire system control unit 206 operates normally. Specifically, the fault sensing unit 215 monitors deadlock of the system bus 204 and the DMA units 216 and 217.

The fault sensing unit 215 sets the bypass mode to the bypass unit 230 if a fault is detected. In other words, the communication apparatus 101 includes the fault sensing unit 215 that senses a fault within the communication apparatus itself, and the bypass unit 230 switches the communication path to the bypass path in a case where a fault is sensed. The fault sensing unit 215 also senses the deadlock of the system bus 204 and the like, so that mode setting to the bypass unit 230 is performed, for example, via a dedicated signal line that does not pass through the system bus 204.

The fault sensing unit 215 may have, for example, a function of directly instructing the power supply control unit 212 to turn off the power and a function of instructing the reset control unit 210 to perform reset processing, in a case of sensing a fault that makes it difficult to communicate in the bypass mode. Faults that make it difficult to communicate in the bypass mode include, for example, detection of an abnormal temperature and detection of an overcurrent in the communication apparatus 101 and the system control unit 206.

Next, bypass change processing for switching between the normal mode and the bypass mode in the communication apparatus 101 will be described with reference to flowcharts.

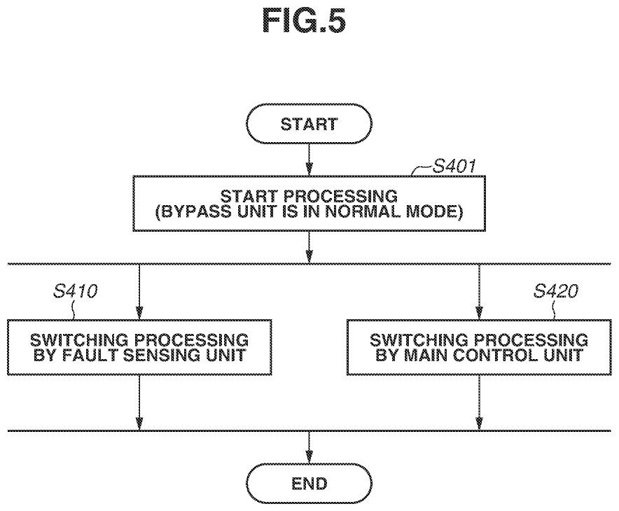

FIGS. 5 to 7 are flowcharts illustrating the bypass change processing.

In step S401, at the time of starting the system, each functional block included in the communication apparatus 101 is reset, and start processing is executed. The bypass unit 230 is started in the normal mode after the start processing.

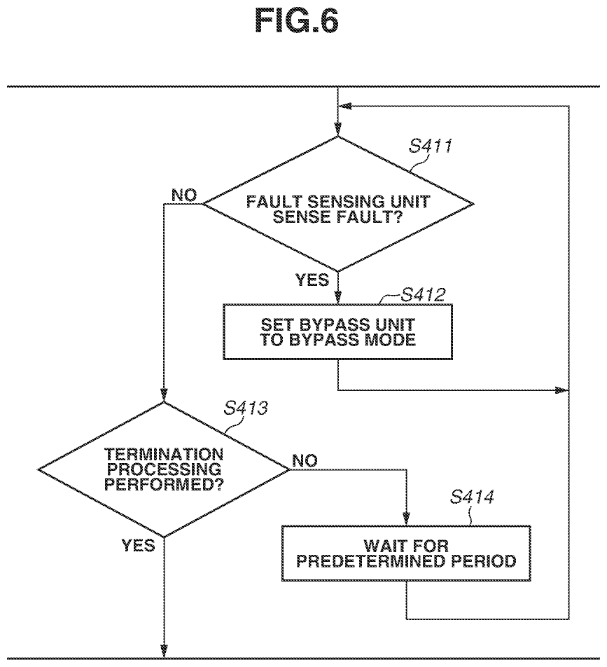

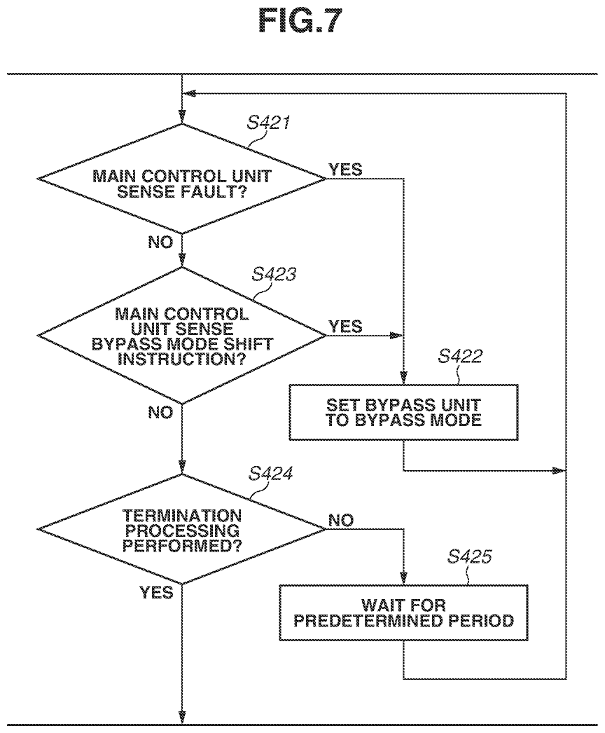

Then, the fault sensing unit 215 and the main control unit 201 switch between the normal mode and the bypass mode. FIG. 5 illustrates switching processing by the fault sensing unit 215 in step S410 and switching processing by the main control unit 201 in step S420. Further, processing procedures in step S410 are illustrated in FIG. 6, and processing procedures in step S420 are illustrated in FIG. 7. The processing in steps S410 and S420 is performed in parallel.

As illustrated in FIG. 6, in step S410, in a case where the fault sensing unit 215 senses a fault (YES in step S411), in step S412, the bypass unit 230 is set to the bypass mode. In a case where the fault sensing unit 215 does not sense a fault (NO in step S411), in step S413, the fault sensing unit 215 determines whether termination processing is performed. In step S414, the above-described processing is repeated at predetermined time intervals until the determination result in step S413 becomes YES. The termination processing includes any one of processing such as processing based on a power-off operation to the system control unit 206, processing for resetting the system control unit 206, and processing for terminating an application in the main control unit 201.

As illustrated in FIG. 7, in step S420, in a case where the main control unit 201 senses a fault (YES in step S421), in step S422, the main control unit 201 sets the bypass unit 230 to the bypass mode. In a case where the main control unit 201 senses a bypass mode shift instruction from the outside (YES in step S423), in step S422, the main control unit 201 also sets the bypass unit 230 to the bypass mode.

Examples of cases where the main control unit 201 senses a fault in step S421 include a case where the OS executed by the main control unit 201 causes a kernel panic, and a case where a fault of another peripheral module is sensed.

There are two major cases for the bypass mode shift instruction to be sensed in step S423.

The first one is a case where control information is included in a packet received from the outside of the communication apparatus 101 and stored in the memory 203, and the bypass mode shift instruction is included as a result of analyzing the packet. The second one is a case where, for example, the communication apparatus 101 receives the bypass mode shift instruction from a user via an interface such as a GUI.

In a case where neither one is sensed (NO in step S423), in step S424, the main control unit 201 determines whether the termination processing is performed. In step S425, the processing from step S421 is repeated at a predetermined timing until the determination result in step S424 becomes YES.

The description will continue by returning to FIG. 2.

The remote control unit 220 monitors a packet received by the interface unit 208 on the root side and input to the bypass unit 230 via a snoop bus 224, and detects a packet that satisfies a specific condition among the packets.

A packet that satisfies the above-described specific condition is a packet for performing remote control on the communication apparatus 101 from the outside, and is hereinbelow referred to as a remote control packet.

The remote control unit 220 includes a detection packet setting unit 221 and a detection unit 222. The detection packet setting unit 221 is set with a necessary condition for the remote control packet by the main control unit 201. Packet monitoring via the snoop bus 224 is performed by the detection unit 222. The detection unit 222 analyzes the packet and detects the remote control packet that satisfies the necessary condition set in the detection packet setting unit 221.

The detection unit 222 executes detection of the remote control packet in a case where the bypass unit 230 is in the bypass mode. The detection unit 222 senses a state of the bypass unit 230 using the bypass state signal 234. The detection unit 222 outputs a packet detection signal 223 upon detecting the remote control packet.

According to the present exemplary embodiment, the detection unit 222 in the remote control unit 220 monitors only a packet from the root side, but packet monitoring may be performed on the leaf side. However, for a system in which the remote control packet is generated only from the server apparatus 102, monitoring is sufficient only on the root side. A configuration that monitors only the root side can reduce a circuit scale, power consumption, and the like, compared with a configuration that monitors the leaf side as well.

According to the present exemplary embodiment, the detection unit 222 in the remote control unit 220 executes detection of the remote control packet in the bypass mode, but detection of the remote control packet may be executed in both of the bypass mode and the normal mode. In other words, the remote control unit 220 detects a specific packet that satisfies the specific condition (the remote control packet) among the packets in a state of being switched to the bypass path by the bypass unit 230.

As the remote control packet, it is desirable to use, for example, a magic Packet® (registered trademark). The magic Packet® is a packet having a data structure such that a value “1” continues 48 times, and then a 6-byte media access control (MAC) address is repeated 16 times.

According to the present exemplary embodiment, a plurality of types of packets is used as the remote control packet, and identification data indicating the type of the remote control packet is given to the magic Packet®. Different types of remote control packets instruct the communication apparatus 101 to perform different control. The detection unit 222 in the remote control unit 220 outputs the packet detection signal 223 having a different value depending on the type of detected remote control packet.

An example of the remote control packet will be described.

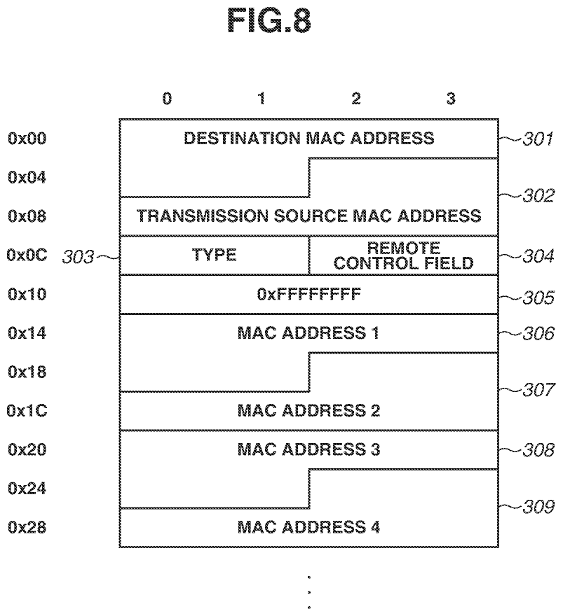

FIG. 8 illustrates an example of the remote control packet.

The remote control packet includes a destination MAC address 301, a transmission source MAC address 302, a type 303, and a remote control field 304. Further, the remote control packet includes a field 305 in which a value “1” continues, and repetition portions of MAC addresses 306, 307, 308, 309, and so on.

In a case where the magic Packet® is transmitted as a payload of an Ethernet frame, the type 303 is set to a value “0*0842”. Thus, according to the present exemplary embodiment, a necessary condition for outputting the packet detection signal 223 is that the value of the type 303 is “0*0842”. In other words, the value “0*0842” of the type 303 is a flag indicating that it is the remote control packet.

The magic Packet® includes a field in which a value “1” continues 48 times (for six bytes), but according to the present exemplary embodiment, a part of the field is changed and, for example, the first two bytes are the remote control field 304. Then, the remaining four bytes are the field 305 in which the value “1” continues. The remote control field 304 stores the identification data indicating the type of the remote control packet. The remote control field 304 may not be a part of the field in which the value “1” continues but be added after 16 repetitions of the MAC addresses 306, 307, 308, 309, and so on.

A destination of the remote control packet is indicated by not the destination MAC address 301 but the MAC addresses 306, 307, 308, 309, and so on, which are repeated 16 times. The destination MAC address 301 includes, for example, a value indicating broadcast communication that does not specify a destination.

As the remote control packet, the magic Packet® included in a User Datagram Protocol (UDP) packet may be used, or a packet in another format may be used. In a case where a remote control packet in another format different from that illustrated in FIG. 8 is used, a condition corresponding to the format of the remote control packet is set in the detection packet setting unit 221. Alternatively, the detection unit 222 having a detection function corresponding to the format of the remote control packet is provided.

Referring back to FIG. 2, description will be given assuming that the remote control packet has the format illustrated in FIG. 8.

The detection unit 222 in the remote control unit 220 according to the present exemplary embodiment detects the remote control packet, for example, by analyzing the value of the type 303. The detection unit 222 in the remote control unit 220 according to the present exemplary embodiment outputs, for example, the packet detection signal 223 having a value equal to a value of the remote control field 304 upon detecting the remote control packet. Accordingly, the value of the packet detection signal 223 becomes a value corresponding to the type of the remote control packet.

The interruption control unit 240 asserts interrupt signals A to D (243 to 246) according to the value of the packet detection signal 223. As described below, the interrupt signals A to D (243 to 246) are asserted, and thus a state of its own apparatus (the communication apparatus 101) is changed. In other words, in a case where the remote control packet is detected, the interruption control unit 240 changes the state of its own apparatus.

A method for responding to the detected remote control packet is not limited to interruption. For example, if the main control unit 201 is in the bypass mode, the main control unit 201 may shift to standby for detection of the remote control packet.

According to the present exemplary embodiment, the remote control packet includes type information indicating the type of the remote control packet, and the interruption control unit 240 changes the state of its own apparatus (the communication apparatus 101) to the state corresponding to the type indicated by the type information included in the remote control packet.

The interruption control unit 240 includes an interruption setting unit 241 and an interruption output unit 242.

The interruption control unit 240 is provided with a setting register (not illustrated) for masking an output of each of the interrupt signals A to D (243 to 246). The interruption control unit 240 is also provided with a control register (not illustrated) for clearing the asserted interrupt signals A to D (243 to 246). Further, the interruption control unit 240 is provided with a status register (not illustrated) for the main control unit 201 to check values of the interrupt signals A to D (243 to 246).

The interruption output unit 242 performs the above-described mask setting and the like, and also determines and outputs the values of the interrupt signals A to D (243 to 246) according to the value of the packet detection signal 223.

The interruption setting unit 241 is set with a correspondence relationship between the value of the packet detection signal 223 and the values of the interrupt signals A to D (243 to 246). The interruption output unit 242 determines the values of the interrupt signals A to D (243 to 246) according to the correspondence relationship set in the interruption setting unit 241 and outputs the interrupt signals A to D (243 to 246).

The interrupt signal A (243) is a signal asserted to the main control unit 201. The main control unit 201 with the interrupt signal A (243) asserted sets the bypass unit 230 to the normal mode. In other words, the interruption control unit 240 can change the state of the communication apparatus 101 from a bypass state in which the bypass path is used to a normal state in which the normal path is used by asserting of the interrupt signal A (243).

The interrupt signal B (244) is a signal asserted to the reset control unit 210. The reset control unit 210 with the interrupt signal B (244) asserted reboots the system control unit 206. In other words, the interruption control unit 240 can change the state of the communication apparatus 101 to a reset state by asserting of the interrupt signal B (244).

The interrupt signals C (245) and D (246) are signals asserted to the power supply control unit 212. The power supply control unit 212 controls ON/OFF of the power supply to the system control unit 206 based on the value of the interrupt signal C (245). Specifically, in a case where the value of the interrupt signal C (245) is “1”, the power supply to the system control unit 206 is turned off. The power supply control unit 212 controls ON/OFF of the power supply to the communication processing unit 207 based on the value the interrupt signal D (246). Specifically, in a case where the value the interrupt signal D (246) is “1”, the power supply to the communication processing unit 207 is turned off.

In a case where only the interrupt signal C (245) is asserted to the power supply control unit 212, the communication apparatus 101 is shifted to the WOL mode in which communication can be performed through the bypass path, and in a case where the interrupt signals C and D (245 and 246) are asserted to the power supply control unit 212, all power supply is turned off.

In other words, the interruption control unit 240 can change the state of the communication apparatus 101 to a partially energized state in which the power supply to the system control unit 206 is cut off and communication through the bypass path is possible by asserting of only the interrupt signal C (245). Further, the interruption control unit 240 can change the state of the communication apparatus 101 to a power supply off state in which all power supply is cut off by asserting of the interrupt signals C and D (245 and 246).

Examples of specific values of the remote control field 304 and the interrupt signals A to D corresponding to a type of remote control with respect to the communication apparatus 101 are described.

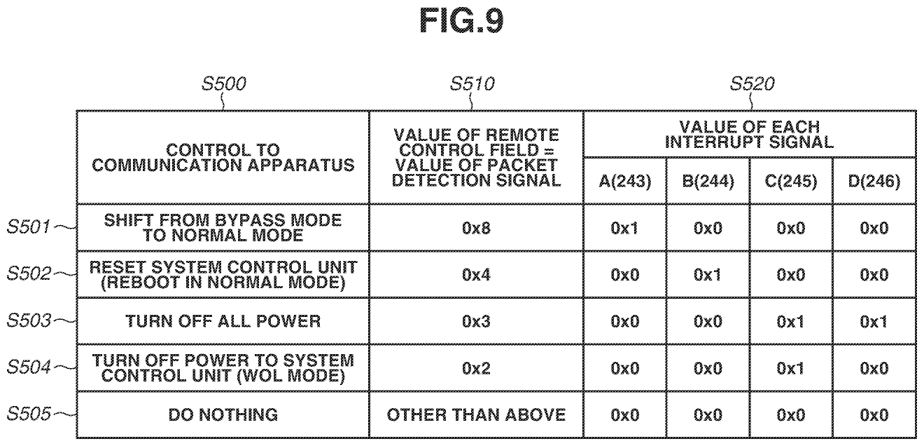

FIG. 9 illustrates a correspondence relationship among the type of remote control, the remote control field 304, and the interrupt signals A to D.

In FIG. 9, four types of control (S501 to S504) are indicated as control items (S500) for the communication apparatus 101 to be performed using the remote control packet, and an item “do nothing” (S505) is also indicated. In FIG. 9, the values of the remote control field 304 are indicated as identification data (S510) of the remote control packet. As described above, the value of the remote control field 304 is the value of the packet detection signal 223. In FIG. 9, each interrupt signal (S520) is indicated in association with the control item (S500) and the identification data (S510).

Specifically, a value “0*8” is set in the remote control field 304 of the remote control packet used for shift control from the bypass mode to the normal mode (S501). Then, in response to the packet detection signal 223 having the value “0*8”, the interrupt signal A has a value “0*1”, and the other interrupt signals B to D have a value “0*0”. In other words, the interrupt signal A is asserted in response to the packet detection signal 223 having the value “0*8”.

A value “0*4” is set in the remote control field 304 of the remote control packet used for reset control to the system control unit 206 (S502). Then, in response to the packet detection signal 223 having the value “0*4”, the interrupt signal B has a value “0*1”, and the other interrupt signals A, C, and D have a value “0*0”. In other words, the interrupt signal B is asserted in response to the packet detection signal 223 having the value “0*4”.

A value “0*3” is set in the remote control field 304 of the remote control packet used for control to turn off all power supply to the communication apparatus 101 (S503). Then, in response to the packet detection signal 223 having the value “0*3”, the interrupt signals C and D have a value “0*1”, and the interrupt signals A and B have a value “0*0”. In other words, the interrupt signals C and D are asserted in response to the packet detection signal 223 having the value “0*3”.

A value “0*2” is set in the remote control field 304 of the remote control packet used for control to turn off the power supply to the system control unit 206 and shift to the WOL mode (S504). Then, in response to the packet detection signal 223 having the value “0*2”, the interrupt signal C has a value “0*1”, and the other interrupt signals A, B, and D have a value “0*0”. In other words, the interrupt signal C is asserted in response to the packet detection signal 223 having the value “0*2”.

In the remote control field 304 of the remote control packet used for doing nothing with respect to the communication apparatus 101 (S505), for example, a value “0*1” other than the values “0*8”, “0*4”, “0*3”, and “0*2” is set. Then, in response to the packet detection signal 223 having the value other than the values “0*8”, “0*4”, “0*3”, and “0*2”, all of the interrupt signals A to D have a value “0*0”. In other words, no interrupt signal is asserted with respect to the packet detection signal 223 having the value other than the values “0*8”, “0*4”, “0*3”, and “0*2”.

To the interruption setting unit 241 in the interruption control unit 240, for example, the correspondence relationship between the identification data (S510) and each interrupt signal (S520) illustrated in FIG. 9 is set.

Next, processing operations in the communication apparatus 101 will be described with reference to flowcharts.

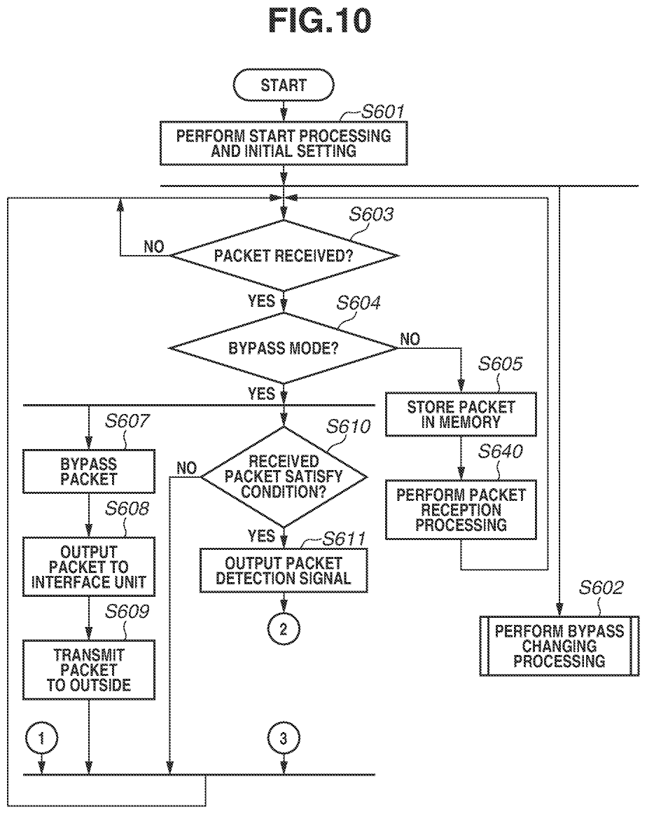

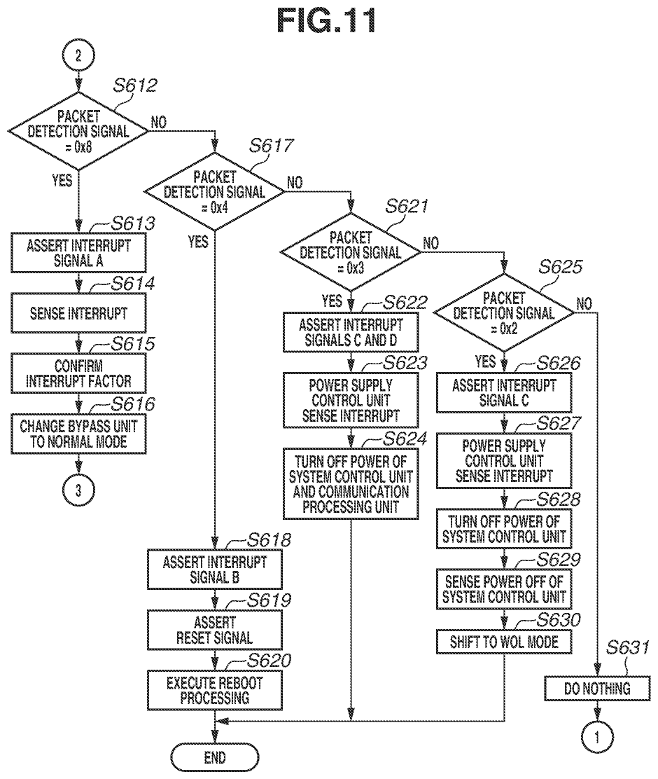

FIGS. 10 and 11 are flowcharts illustrating the processing operations in the communication apparatus 101.

Circled numbers in FIGS. 10 and 11 indicate that the flow in FIG. 10 and the flow in FIG. 11 are connected at the point with the same number.

In step S601, when the communication apparatus 101 is started, start processing and an initial setting are executed. The start processing in step S601 includes the processing in step S401 in FIG. 5. The initial setting in step S601 includes, for example, setting of the correspondence relationship illustrated in FIG. 9 with respect to the interruption setting unit 241 in the interruption control unit 240. The initial setting in step S601 also includes setting of a MAC address value indicating itself with respect to the detection packet setting unit 221 in the remote control unit 220. In the initial setting in step S601, other information for determining the remote control packet may be set. For example, in a case where a value other than “0*0842” is used to the type 303 of the remote control packet, the value may be set in the detection packet setting unit 221 in the remote control unit 220.

After the processing in step S601, in step S602, the processing in steps S410 and S420 in the bypass change processing illustrated in FIGS. 5 to 7 is appropriately repeated in parallel.

After the processing in step S601, in a case where the communication apparatus 101 receives a packet from the interface unit 208 or 209 (YES in step S603), the processing branches according to the mode of the bypass unit 230.

In a case where the bypass unit 230 is in the normal mode (NO in step S604), normal processing is executed. In other words, in step S605, the DMA unit on the receiving side of the DMA unit 216 on the root side and the DMA unit 217 on the leaf side stores the received packet in the memory 203. Then, in step S640, the main control unit 201 performs reception processing of the packet.

On the other hand, in a case where the bypass unit 230 is in the bypass mode (YES in step S604), in steps S607 to 609, processing for bypassing the packet is executed regardless of whether the packet is the remote control packet or not. Specifically, in step S607, the bypass unit 230 bypasses the packet from the receiving side to the output side within the bypass unit 230. In step S608, the communication processing unit 207 outputs the received packet to the interface unit 208 or 209 on the output side. Then, in step S609, the communication apparatus 101 transmits the packet to the outside via the interface unit 208 or 209 on the output side.

The packet received from the interface unit 208 on the root side in the bypass mode is analyzed by the detection unit 222 in the remote control unit 220 to determine whether the packet satisfies a predetermined condition set in the detection packet setting unit 221. Specifically, the detection unit 222 analyzes the value of the type 303 as a flag indicating the remote control packet. The detection unit 222 also analyzes the repeated MAC addresses 306, 307, 308, 309, and so on as the destination of the remote control packet.

In other words, the detection unit 222 detects a packet including specific flag information as the remote control packet among the packets. The remote control packet includes destination information indicating the destination of the remote control packet, and the detection unit 222 detects the remote control packet including the destination information indicating its own apparatus among the remote control packets.

Then, in a case where the received packet does not satisfy the predetermined condition (NO in step S610), the subsequent processing is not generated in the remote control unit 220, and the processing returns to step S603. Cases where the predetermined condition is not satisfied include, for example, a case where the received packet is not the remote control packet (a flag is different), and a case where the remote control packet is not addressed to its own apparatus (the MAC address is different).

In a case where the received packet satisfies the above-described predetermined condition (YES in step S610), in step S611, the remote control unit 220 outputs the packet detection signal 223.

In a case where the value of the packet detection signal 223 is “0*8” (YES in step S612), in step S613, the interruption output unit 242 in the interruption control unit 240 asserts the interrupt signal A (243). In step S614, the main control unit 201 senses the interrupt signal A (243) and, in step S615, accesses the interruption control unit 240 to check an interrupt factor. In step S616, after confirming that the interrupt factor is caused by the remote control unit 220, the main control unit 201 transmits a signal instructing the normal mode to the bypass unit 230 and changes the bypass unit 230 to the normal mode. As a result, the received packet is stored in the memory 203, and the main control unit 201 can access the received packet. Then, the processing in the communication apparatus 101 returns to step S603.

In a case where the value of the packet detection signal 223 is “0*4” (YES in step S617), in step S618, the interruption output unit 242 in the interruption control unit 240 asserts the interrupt signal B (244) to the reset control unit 210. In step S619, the reset control unit 210 with the interrupt signal B (244) asserted asserts the reset signal 211 to the system control unit 206. In step S620, the system control unit 206 with the reset signal 211 asserted is reset and executes reboot processing. As a result, the processing in FIGS. 10 and 11 is temporarily terminated, the processing is restarted from step S601, and the bypass unit 230 also returns to the normal mode.

In a case where the value of the packet detection signal 223 is “0*3” (YES in step S621), in step S622, the interruption output unit 242 in the interruption control unit 240 asserts the interrupt signals C and D (245 and 246) to the power supply control unit 212. In step S623, the power supply control unit 212 receives and senses the interrupt signals C and D (245 and 246) and, in step S624, turns off the power supply to the system control unit 206 and the communication processing unit 207. As a result, the communication apparatus 101 stops the operation.

In a case where the value of the packet detection signal 223 is “0*2” (YES in step S625), in step S626, the interruption output unit 242 in the interruption control unit 240 asserts the interrupt signal C (245) to the power supply control unit 212. In step S627, the power supply control unit 212 receives and senses the interrupt signal C (245) and, in step S628, turns off the power supply to the system control unit 206. As a result, in step S629, the communication processing unit 207 senses the power supply off of the system control unit 206 and, in step S630, shifts to the WOL mode.

In a case where the value of the packet detection signal 223 is not “0*8”, “0*4”, “0*3”, or “0*2” (NO in step S625), in step S631, the remote control unit 220 does not execute the processing, and the processing in the communication apparatus 101 returns to step S603.

### Other Embodiments

Various embodiments of the present disclosure can be implemented by an exemplary embodiment such as, a system, an apparatus, a method, a program, or a recording medium (a storage medium). Specifically, various embodiments of the present disclosure may be applied to a system including a plurality of devices (for example, a host computer, an interface device, and a web application) or an apparatus including one device.

Various embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The functions of the above-described exemplary embodiments may be realized not only by a computer executing a read program but also by an operating system (OS) operating on the computer executing a part or all of actual processing based on an instruction of the program, for example.

Further, the functions of the above-described exemplary embodiments may also be realized in such a manner that a program read from a storage medium is written into a memory included in a function expansion card inserted into a computer or a function expansion unit connected to the computer, and then a CPU provided in the function expansion card or the function expansion unit executes a part or all of the actual processing based on an instruction of the program.

In a case where embodiments of the present disclosure are applied to the above-described storage medium, the storage medium stores a program corresponding to the above-described flowcharts.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-101714, filed Jun. 24, 2022, which is hereby incorporated by reference herein in its entirety.

What is claimed is:

1. A communication apparatus comprising:
an input unit configured to be input a packet from a first communication line;
an output unit configured to output the packet to a second communication line;
a processing unit configured to process the packet;
a switching unit configured to switch a path for outputting, from the output unit, the packet input from the input unit between a normal path passing through an access point that the processing unit can access and a bypass path not passing through the access point;
a detection unit configured to detect a specific packet that satisfies a specific condition from among a plurality of packets in a state where the path is switched to the bypass path by the switching unit; and
a changing unit configured to change a state of the communication apparatus in a case where the specific packet is detected.

2. The communication apparatus according to claim 1, further comprising a sensing unit configured to sense a fault in the communication apparatus,
wherein the switching unit switches the path to the bypass path in a case where the fault is sensed.

3. The communication apparatus according to claim 1,
wherein the specific packet includes type information indicating a type of the specific packet, and
wherein the changing unit changes the communication apparatus to a state corresponding to the type indicated by the type information included in the specific packet.

4. The communication apparatus according to claim 1, wherein the changing unit changes a state of the communication apparatus to a reset state.

5. The communication apparatus according to claim 1, wherein the changing unit changes a state of the communication apparatus from a bypass state in which the bypass path is used to a normal state in which the normal path is used.

6. The communication apparatus according to claim 1, wherein the changing unit changes a state of the communication apparatus to a partially energized state in which power supply to the processing unit is cut off and communication through the bypass path is possible.

7. The communication apparatus according to claim 1, wherein the changing unit changes a state of the communication apparatus to a power supply off state in which all power supply is cut off.

8. The communication apparatus according to claim 1, wherein the detection unit detects a packet including specific flag information as the specific packet among the packets.

9. The communication apparatus according to claim 1,
wherein the specific packet includes destination information indicating a destination of the specific packet, and
wherein the detection unit detects a specific packet including destination information indicating the communication apparatus in the specific packet.

10. A communication system comprising:
a plurality of communication apparatuses according to claim 1 in daisy chain connection via a communication line; and
a server apparatus configured to communicate the packet with each of the plurality of communication apparatuses.

11. The communication system according to claim 10, wherein the server apparatus transmits the specific packet to the communication apparatus.
